(19) United States
(12) Patent Application Publication
(10) Pub. No.: US 2006/0125290 A1
(43) Pub. Date: Jun. 15, 2006

(54) Body for a motor vehicle comprising a roof column

(76) Inventors: Konrad Eipper, Rottenburg (DE); Wolfgang Fussnegger, Tuebingen (DE); Christian Mayer, Renningen (DE); Bernhard Spies, Sindelfingen (DE); Carlos Valdivieso, Tiefenbronn (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/525,718

(22) PCT Filed: Aug. 8, 2003
(86) PCT No.: PCT/EP03/08819

§ 371 Date: Oct. 4, 2005

(30) Foreign Application Priority Data
Aug. 27, 2002 (DE) 102 39 991.3

(51) Int. Cl. B62D 27/02

(52) U.S. Cl. 296/203.03

(57) ABSTRACT

The invention relates to a body for a motor vehicle, which comprises a support structure (10) having a roof module (42) which is placed onto a basic module (12), a roof column (50) extending between the roof (43) of the roof module (42) and the basic module (12), which roof column is to be fixed at its lower end (64) on the basic module (12) during assembly of the partial modules (12, 26, 42, 50, 52).

In order to achieve a different modularization of the support structure (10) with an improved crash stability of the body, the roof column (50) is designed as a separate component which is to be fastened at its upper end (60) in an overlapping manner to a support part (62) protruding from the roof (43).

### BACKGROUND AND SUMMARY OF THE INVENTION

This invention relates to a body for a motor vehicle.

A body of this type which comprises a support structure having a roof module which is placed onto a basic module is already known from German document DE 35 40 814 C2. In this case, the roof module is assigned B-columns which are fastened to the roof module and extend between the roof of the roof module and the basic module. During assembly of the partial modules, the roof columns are to be fixed at their lower end in each case to the basic module. For this purpose, the roof columns have to be plugged onto receiving profiles on lateral longitudinal members and fastened thereto.

Japanese document JP 09 254 812 A illustrates a motor vehicle body which is assembled in a conventional sheet-metal shell-type construction having a multiplicity of individual sheet-metal sections, in particular by spot welding or other customary joining connections. In this case, a roof column extends between the roof and the side sill. During assembly of the individual sheet-metal sections of the roof column, one of the column sheets is to be fastened at its upper end in an overlapping manner and from the outside to a support part protruding from a roof section.

European document EP-A-1 170 197 likewise shows a conventional sheet-metal shell-type construction having a multiplicity of individual sheet-metal sections. In this case, the inner shell of a B-column is designed as an integral part of the inner shell of the entire side wall of the motor vehicle. Japanese document JP11 059489 A also shows a similar construction. Here too, the inner shell of the B-column is already designed as an integral part of the inner shell of the entire side wall of the motor vehicle.

Finally, Japanese document JP 2001 106118A also shows a support structure which has been produced in a conventional construction. In this case, a roof column is fastened on the upper side to a support part of the roof in an overlapping manner, the connection of the two sheet-metal shells of the roof columns taking place by placing the roof onto the column. At its lower end, the roof column is connected fixedly to the door sill.

An object of the invention is the object of creating a body of the type mentioned at the beginning with a different modularization and with improved crash stability.

This object is achieved according to the invention by way of a body with a roof column designed as a separate component, as a result of which the roof module and the roof columns can be connected to each other or to the basic module in a simple manner in terms of manufacturing during the assembly of the modules. The overlapping fastening of the upper end of the roof column to the support part protruding from the roof results in an extremely stable fastening, for example, against a side impact on the assembled body. In addition, the overlapping arrangement of the two components can produce a very stable fastening, which can easily be reproduced for series vehicle construction, by means of a joining connection or a mechanical connection or the like.

In the case of a side impact on the assembled body, it is advantageous if the roof column is fastened from the outside to the support part and the support part acts as a tie rod for the upper end of the roof column.

The upper end of the roof column is fixed particularly readily to the roof module if the support part is fixed on a lateral roof strut of the roof module. If the roof column comprises at its upper end a bearing section via which the roof column is supported from the outside against the roof strut, then in addition to the overlapping with the support part, an additional, stable overlapping of the roof column with the roof strut is provided.

The arrangement of the bearing section within a recess of the roof strut first ensures a particularly stable fastening of the roof column to the roof strut and secondly enables the bearing section to be integrated in the roof strut flush with its surface.

A particularly good fastening of the lower end of the roof column to the lateral longitudinal member of the basic module is provided if the roof column ends at the lower end on a fastening profile which, when installed, runs in the direction of extent of the lateral longitudinal member. This fastening profile preferably is of essentially U-shaped design in cross section and is able to be plugged in an essentially form-fitting manner onto the lateral longitudinal member. Since the roof column can be fitted at the lower and upper ends in two different fastening directions, namely is placed on it from above at the lower end and from the outside at the upper end in the direction of the center of the vehicle, a very stable arrangement of the roof column on the support structure is achieved. In addition, a simple, easily reproducible installation of the roof column is achieved by plugging on the lower end and then fixing the upper end.

Further advantages, features and details of the invention emerge from the description below of a preferred exemplary embodiment and with reference to the drawings.

### BRIEF DESCRIPTION OF THE DRAWINGS

FIG. 1 shows a perspective exploded illustration of the support structure of the motor vehicle body according to the invention, which support structure is assembled from large-size partial modules;

FIG. 2 shows a further perspective exploded illustration of the support structure which is assembled from partial modules and is lined with outer panel parts;

FIG. 3 shows a perspective view of a roof module on which support parts are provided for fixing the B-columns;

FIG. 4 shows a perspective view of the roof column which can be fixed on the roof module and on the basic module; and

FIG. 5 shows an enlarged partial side view from the interior of the body of the fastening of the upper end of the roof column to the support part of the roof module.

### DETAILED DESCRIPTION OF THE INVENTION

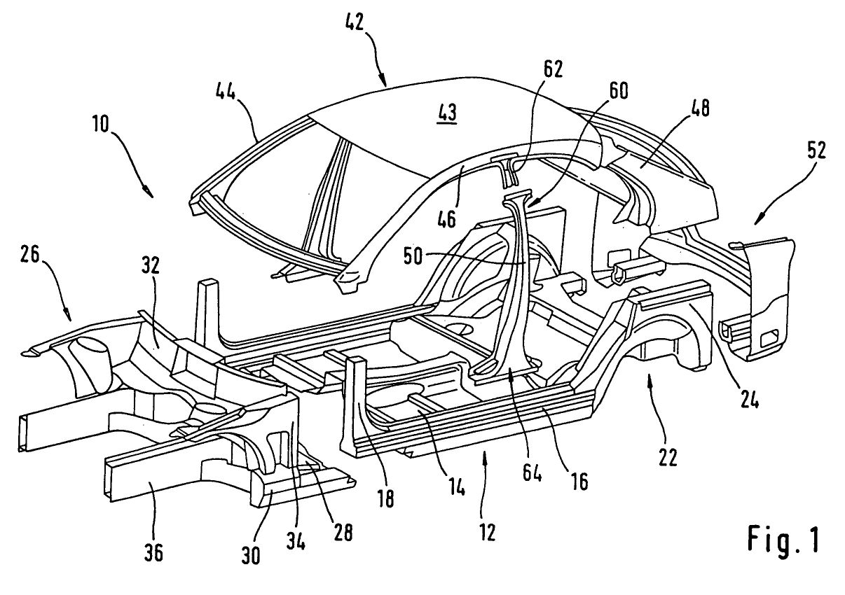

FIG. 1 shows, in a perspective exploded illustration, a support structure 10 of a motor vehicle body which is assembled from a plurality of large-size partial modules which are described in more detail below. In the exemplary embodiment shown here, the partial modules of the support structure 10 are produced in each case from a plurality of sheet-metal parts which are joined together; at the same time, however, the partial modules may also be premanufactured in different constructions, for example as a “space frame”, as plastic parts, metal cast parts, as components in a “sandwich construction” or the like. In particular, combinations of different constructions for the partial modules which are fitted together are also conceivable, depending on the application and loading. The individual modules are connected in particular via bonding connections, welding connections or other customary connections, such as screw connections or the like.

A basic module 12 of the support structure 10 essentially comprises a body floor 14 which is bounded laterally by longitudinal members 16. The basic module 12 reaches forward as far as column sections 18 of front wall columns which protrude upward from the respectively associated front ends of the lateral longitudinal members 16. The body floor 14 of the basic module 12 ends at a considerable distance behind the front end of the basic module 12 or behind the column sections 18 of the front wall columns. At the rear, the basic module 12 ends behind rear wheel houses 22 above which wall regions 24 of the particular rear side wall are arranged. The basic module 12 is already equipped as far as possible with the other partial modules before it is fitted together.

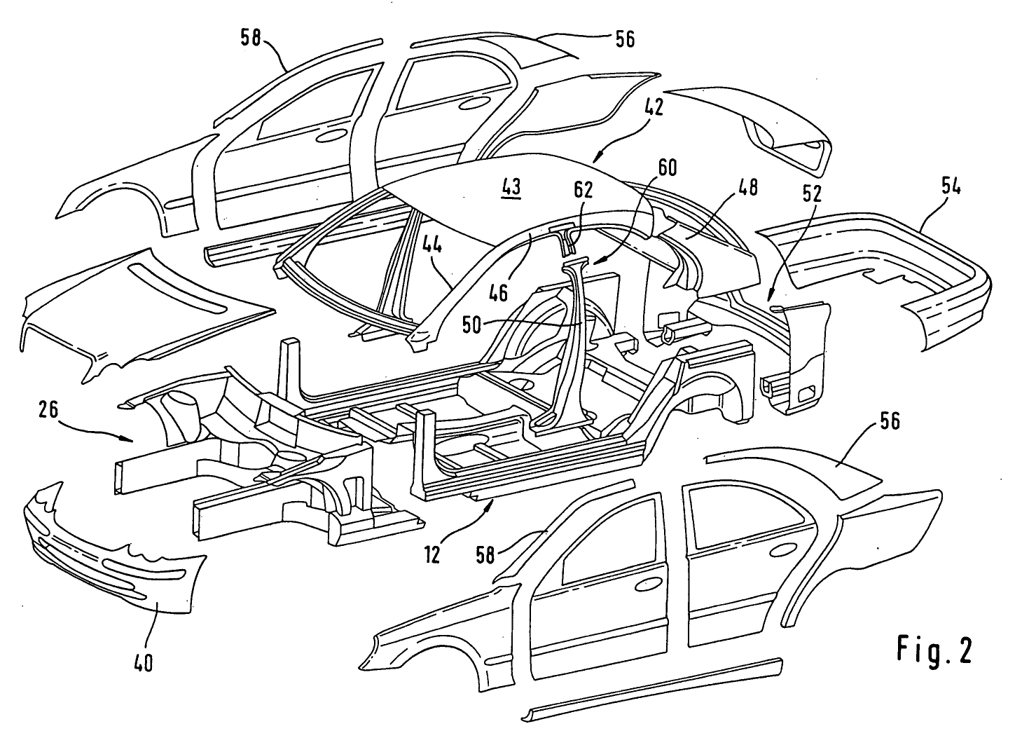

A front end module 26 which belongs to the front crumple zone of the motor vehicle and is supported in a crash stable manner on the basic module 12 is connected to the basic module 12. For this purpose, the front end module 26 comprises a front end region 28 of the body floor 14, which extends between lateral longitudinal member sections 30 of the front end module 26. The front end region 28 of the body floor 14 ends forward at a front end wall 32 of the passenger cell, which wall extends from the front end region 28 of the body floor 14 to approximately level with the side wall edge of the support structure 10. The end wall 32 is bounded laterally by column sections 34 of the front wall columns that protrude upward from the lateral longitudinal member sections 30 of the front end module 26. At the front end of the front end module 26 front longitudinal members 36 can be seen. The front end module 26 is forwardly adjoined by a front module 40 which is partially illustrated in FIG. 2 and comprises, for example, the front bumper.

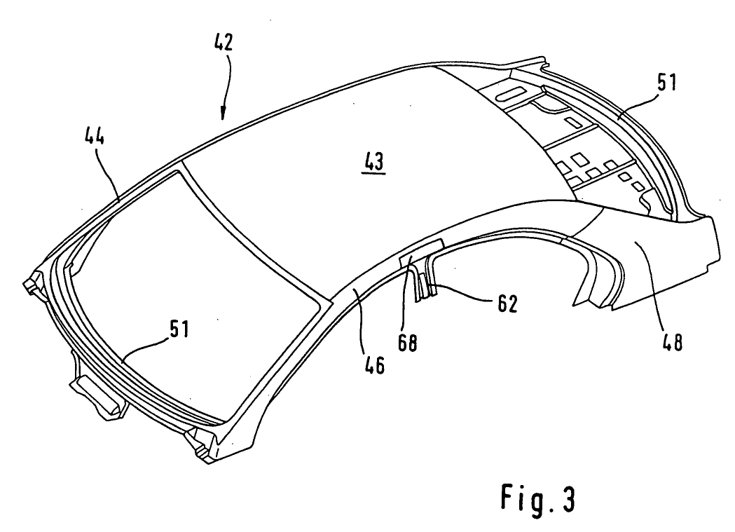

A roof module 42, which can be seen in overall view in FIG. 3, can be placed onto the basic module 12 and the front end module 26 and here comprises lateral A-columns 44, lateral roof struts 46 in the region of the roof 43, and C-columns 48. The lower ends of the A-columns 44 and of the C-columns 48 are connected to one another via a respective crossmember element 51. When the support structure 10 is assembled, the A-columns 44 are supported on the basic module 12 and on the front end module 26. At the rear, the lower ends of the C-columns 48 are supported on the respectively assigned upper end of the wall regions 24, the modules 12, 42 being connected to each other, for example, by means of a bonding connection.

At the rear, the basic module 12 is adjoined by a rear module 52 which, when the support structure 10 is assembled, belongs together with the rear end region of the basic module 12 to the rear crumple zone of the motor vehicle and bounds a trunk to the rear. To the rear, the rear module 52 is adjoined by a rear end module with a rear bumper 54 which can be seen in FIG. 2.

A roof column 50 which is designed as a B-column extends in each case between the roof strut 46 of the roof module 42, which roof strut laterally bounds the roof 43, and the lateral longitudinal member 16 of the basic module 12. This roof column 50 is designed as a separate component and, during the assembly of the partial modules 12, 26, 42, 50, 52, is to be fixed in a manner explained in more detail below at its upper end 60 in an overlapping manner on a support part 62, which protrudes from the roof strut 46 of the roof 43, and at its lower end 64 on the basic module 12.

FIG. 2 illustrates, in a further perspective exploded illustration, the support structure 10 which is assembled from the partial modules 12, 26, 42 and 52 and, in the region of the front and rear wings and of the sill, is lined with outer panel parts of plastic, sheet metal or the like. The A-columns 44, the roof struts 46 and the C-columns 48 are lined in this case with column lining parts 56, 58.

In FIG. 3, which shows the roof module 42 in a perspective view, the support part 62, which protrudes downward from the roof strut 46 of the roof 43 and is intended for fixing the B-column 50, can be seen. The support part 62 can be formed integrally with the lateral roof strut 46 or else can be designed as a separate component which is fixed on the roof module 42 during production of the latter.

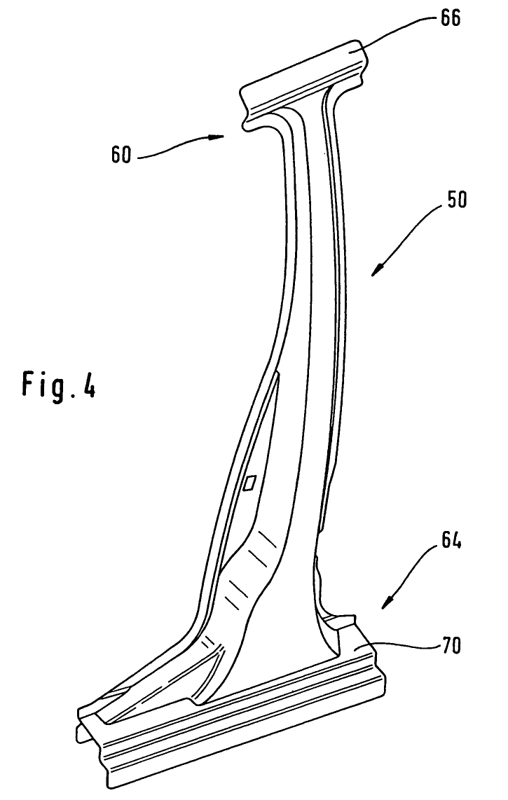

As is apparent in perspective view from FIG. 4, the roof column 50 comprises at its upper end 60 a bearing section 66 which protrudes in a T-shaped manner, runs in the direction of extent of the roof strut 46 and via which the roof column 50 is supported from the outside against the roof strut 46. In other words, the roof column 50 is not only supported from the outside against the downwardly protruding support part 62 but also on the roof strut 46. In order to accommodate and stably fix the roof column 60 on the roof strut 46, the latter has a recess 68, which can be seen in FIG. 3, within which the bearing section 66 of the roof column 46, which bearing section is fastened to the upper end of the roof strut 46, lies. In this case, the recess 68 is preferably matched to the shape of the bearing section 66, the latter being integrated in the roof strut 46 flush with its surface.

The lower end 64 of the roof column 50 is enlarged—as viewed in the transverse direction of the vehicle—triangularly in cross section and ends on a fastening profile 70 which, when installed, runs in the direction of extent of the lateral longitudinal member 16 of the basic module 12. This fastening profile 70—as viewed in the longitudinal direction of the vehicle—is of essentially U-shaped design in cross section and can be fastened in an essentially form-fitting manner on the associated, lateral longitudinal member 16 of the basic module 12. It is clear that by fitting it around the lateral longitudinal member 16 an extremely stable fastening of the roof column 50 to the longitudinal member 16 can be obtained. The fastening profile 70 is designed here as two shells with an inner installation part.

The roof column 50 is formed here from two sheet-metal shells welded to each other. At the same time, other materials or constructions of the roof column 50, for example as a space frame, from plastic parts, from metal cast parts, as components in a sandwich construction or the like, are also conceivable.

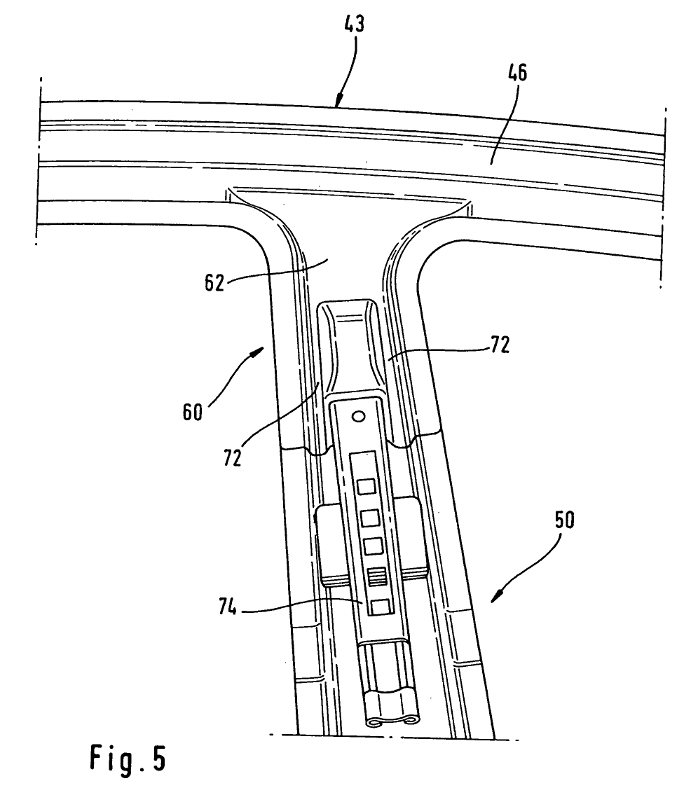

FIG. 5 shows, in an enlarged partial side view from the interior of the body, the fastening of the upper end 60 of the roof column 50 to the support part 62. In this case, the arrangement of the support part 62 on the roof strut 46 can be seen. The support part 62 is provided with a profile with ribs 72, the profile running in the direction of extent of the roof column 50 and being matched in cross section to the shape of the profile of the roof column 50. It can be seen that the upper end 60 of the roof column 50 is arranged in an overlapping manner with respect to the support part 62. For the stable fastening of the roof column 50 to the support part 62, a joining connection, such as a welding connection or bonding connection and/or a mechanical connection, such as a screw connection, can be provided. In the exemplary embodiment shown here, the upper end 60 of the roof column 50 and the support part 62 are additionally connected to each other via a rail 74 of a seat belt system.

It is clear that the manner in which the roof column 50 is arranged and configured is possible not only—as in the exemplary embodiment shown here—for the B-columns of the motor vehicle. The use, for example in an A-, C- or D-column, would, of course, also be conceivable.

1-11. (canceled)

12. A body for a motor vehicle having a support structure which is assembled from large-size partial modules comprising:
a roof module,
a basic module onto which the roof module is placed, and
a roof column extending between a roof of the roof module and the basic module, which roof column is to be fixed at its lower end on the basic module during assembly of the partial modules,
wherein the roof column is designed as a separate component which, after assembly of the basic module and the roof module, is to be fastened at its upper end in an overlapping manner and from outside to a support part protruding from the roof.

13. The body as claimed in claim 12, wherein the support part is fixed on a lateral roof strut of the roof module.

14. The body as claimed in claim 13, wherein the roof column comprises at its upper end a bearing section via which the roof column is supported from outside against the roof strut.

15. The body as claimed in claim 14, wherein the roof strut has a recess within which the bearing section of the roof column lies, and wherein the bearing section is fastened to the roof strut.

16. The body as claimed in claim 12, wherein the support part is matched in cross section to a shape of the roof column and runs in a direction of extent of the roof column.

17. The body as claimed in claim 12, wherein the roof column and the support part are additionally connected to each other via a rail of a seat belt system.

18. The body as claimed in claim 12, wherein the lower end of the roof column is to be fixed on a lateral longitudinal member of the basic module.

19. The body as claimed in claim 18, wherein the roof column is enlarged in cross section at the lower end and ends on a fastening profile which, when installed, runs in a direction of extent of the lateral longitudinal member.

20. The body as claimed in claim 19, wherein the fastening profile is of essentially U-shaped design in cross section and can be plugged onto the lateral longitudinal member.

21. The body as claimed in claim 20, wherein the fastening profile can be fastened in an essentially form-fitting manner to the lateral longitudinal member.

22. An assembly process for a body for a motor vehicle having a support structure which is assembled from large-size partial modules and including a roof module which is placed onto a basic module, a roof column designed as a separate component and extending between a roof of the roof module and the basic module, which roof column is to be fixed at its lower end on the basic module during assembly of the partial modules, comprising:
assembling the basic module and the roof module, and
subsequently fastening the roof column at its upper end in an overlapping manner and from outside to a support part protruding from the roof.
